(19) United States
(12) Patent Application Publication
(10) Pub. No.: US 2012/0275157 A1
(43) Pub. Date: Nov. 1, 2012

(54) LAMP STRING STRUCTURE FOR EMITTING LIGHT WITHIN WIDE AREA

(76) Inventor: Yu-Mou HSU, Hsinchu City (TW)

(21) Appl. No.: 13/094,583

(22) Filed: Apr. 26, 2011

(51) Int. Cl. F21S 4/00

(52) U.S. Cl. 362/249.06; 362/249.14

(57) ABSTRACT

A lamp string structure for emitting light within wide area includes a first conductive wire and a second conductive wire parallel with each other, and at least one lighting element located between the first and second conductive wires. The lighting element has a first conductive filament and a second conductive filament electrically connected to the first and second conductive wires respectively. The lighting element is encased by a package body which has an insulation holding layer to hold the lighting element and an insulation covering layer connected to the insulation holding layer to cover the lighting element. The insulation holding layer and insulation covering layer are light transparent. Thus the lighting element can emit light radially without being constrained by light emission angles and also dissipate heat generated by the lighting element during light emission to reduce heat accumulation.

### FIELD OF THE INVENTION

The present invention relates to a lamp string structure for emitting light within wide area and particularly to a lamp string structure used on lighting fixtures without being restricted by light emission angles.

### BACKGROUND OF THE INVENTION

With constant advance of technology, people have higher and higher energy saving consciousness. Light emitting diode (LED) provides many advantages, such as greater luminosity, smaller size, less power consumption and longer lifespan, hence is widely adopted on lighting fixtures.

At present, the lighting fixtures with the LEDs have been commonly used for illumination or light indication, such as street lights, desk lamps, flashlights, traffic lights, vehicle turning lights or brake lights, etc. They also are adaptable to ornamental lighting fixtures, such as Christmas lights. The ornamental lighting fixture has multiple LEDs installed on a power cord spaced from each other to form an elongate lamp string to be wound or hung on an ornamental target object. The LEDs can emit varying color lights to achieve desired ornamental purpose.

For instance, R.O.C. patent No. 581188 discloses a parallel lamp string which includes a first conductive wire and a second conductive wire parallel with each other and a plurality of lighting elements. Each lighting element has a first electrode and a second electrode at two opposite sides. The first electrode is electrically fastened to the first conductive wire, and the second electrode is electrically connected to the second conductive wire. Each lighting element further is sealed by light transparent insulation resin to be isolated from the exterior.

U.S. Pat. No. 7,235,815 also provides an LED light set which mainly includes two conductive wires. One conductive wire is pre-processed to form a holding area to hold an LED. The LED is connected to the two conductive wires through two conductive filaments to transmit electric power to the LED.

All the aforesaid conventional techniques provide an LED lamp string with the LEDs located on one conductive wire. Such an approach creates many problems, notably:

1. The light emitted from the LED on the coupling surface is totally blocked by the conductive wire, hence light emission angles of the LED are limited. The LED can emit light towards only a certain area.

2. Since the light is blocked by the conductive wire, heat generated by the LED during light emission cannot be conducted outside. As a result, heat accumulation occurs to affect the lifespan of the LED.

3. The LEDs located on the conductive wire could be compressed when the conductive wire is bent, hence bending effect is not desirable. As a result, the LEDs cannot be applied to all types of target objects to be decorated.

4. Multiple holding areas are formed on the conductive wire through a pressing process. Thus more production time is needed and production efficiency is lowered.

### SUMMARY OF THE INVENTION

The primary object of the present invention is to solve the problems of conventional lamp strings that have insufficient light emission angles and are incapable of dissipating accumulated heat.

To achieve the foregoing object, the present invention provides a lamp string structure for emitting light within wide area that includes a first conductive wire, a second conductive wire and at least one lighting element. The first and second conductive wires are parallel with each other. The lighting element is located between the first and second conductive wires, and has a first conductive filament and a second conductive filament that are electrically connected to the first and second conductive wires respectively. The lighting element is encased by a package body which has an insulation holding layer to hold the lighting element and an insulation covering layer connected to the insulation holding layer to cover the lighting element. The insulation holding layer and insulation covering layer are light transparent.

In an embodiment of the invention, the lighting element is an LED dice, such as an LED bipolar dice or an LED mono-polar dice, or a SMD (Surface Mount Device) LED. The insulation holding layer and insulation covering layer encase the first and second conductive filaments and first and second conductive wires. The insulation holding layer and insulation covering layer are respectively made of package material and integrally formed in a mold. Moreover, the insulation holding layer is a transparent film platform, and the insulation covering layer is the package material to cover the insulation holding layer.

Through the technique set forth above, the invention can provide wide-angle light projection without being constrained by the conductive wires, and heat also can be fully conducted outside without generating accumulated heat. There is also no need to do extra process on the conductive wires, thus production time can be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a sectional view of an embodiment of the invention.

FIG. 3 is a sectional view of another embodiment of the invention.

FIGS. 4A through 4F are schematic views showing a fabrication process of the invention.

FIGS. 5A through 5C are schematic views showing another fabrication process of the invention.

### DETAILED DESCRIPTION OF THE PREFERRED EMBODIMENTS

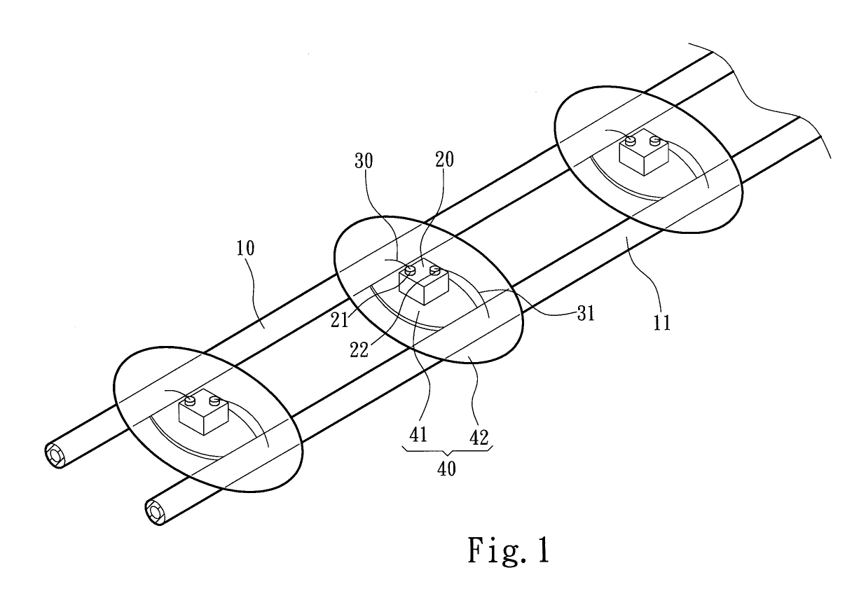

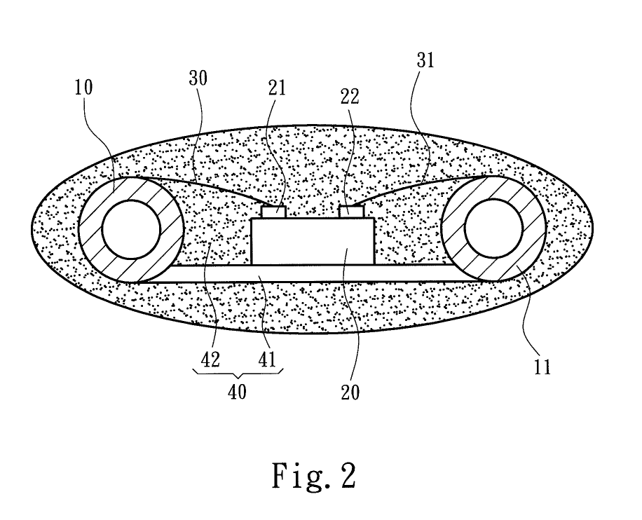

Please refer to FIGS. 1 and 2, the present invention aims to provide a lamp string structure for emitting light within wide area that mainly includes a first conductive wire 10, a second conductive wire 11, at least one lighting element 20 and a package body 40. The first and second conductive wires 10 and 11 are parallel with each other and connected to a power source to transmit electric power. In an embodiment of the invention, the lighting element 20 consists of multiple sets each is an LED dice. In the drawings, the LED dice is a bipolar dice with a first electrode 21 and a second electrode 22 at one side. The lighting elements 20 are located between the first and second conductive wires 10 and 11 and spaced from each other at a selected distance. Each lighting element 20 has a first conductive filament 30 and a second conductive filament 31 that are connected respectively to the first and second electrodes 21 and 22. Through the first conductive filament 30 connected to the first conductive wire 10 and the second conductive filament 31 connected to the second conductive wire 11, the lighting elements 20 can receive the electric power to emit light. The package body 40 encases the lighting element 20 and includes an insulation holding layer 41 to hold the lighting element 20 and an insulation covering layer 42 connected to the insulation holding layer 41 to cover the lighting element 20. The insulation holding layer 41 and insulation covering layer 42 isolate the lighting element 20 from the exterior. The insulation holding layer 41 and insulation covering layer 42 are light transparent to allow light emitted from the lighting element 20 to pass through, thus is formed the main structure of the invention.

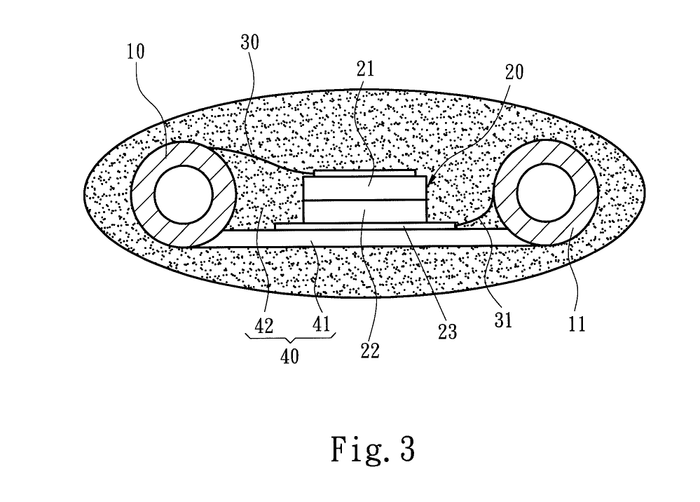

In an embodiment of the invention, referring to FIG. 3, the lighting element 20 can be an LED mono-polar dice including the first electrode 21 and the second electrode 22 respectively at the upper and lower portions. The first electrode 21 and the second electrode 22 are connected respectively to the first conductive filament 30 and second conductive filament 31, and are fixedly mounted onto the transparent insulation holding layer 41 through a transparent conductive resin 23. Aside from the embodiment previously discussed, the lighting element 20 may also be a SMD LED (not shown in the drawings).

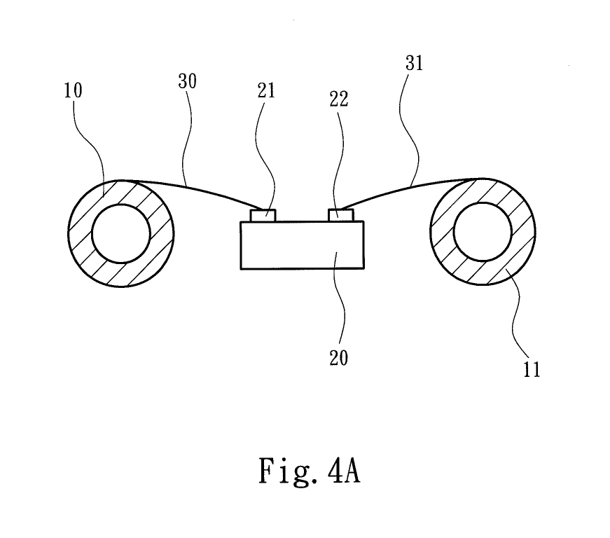

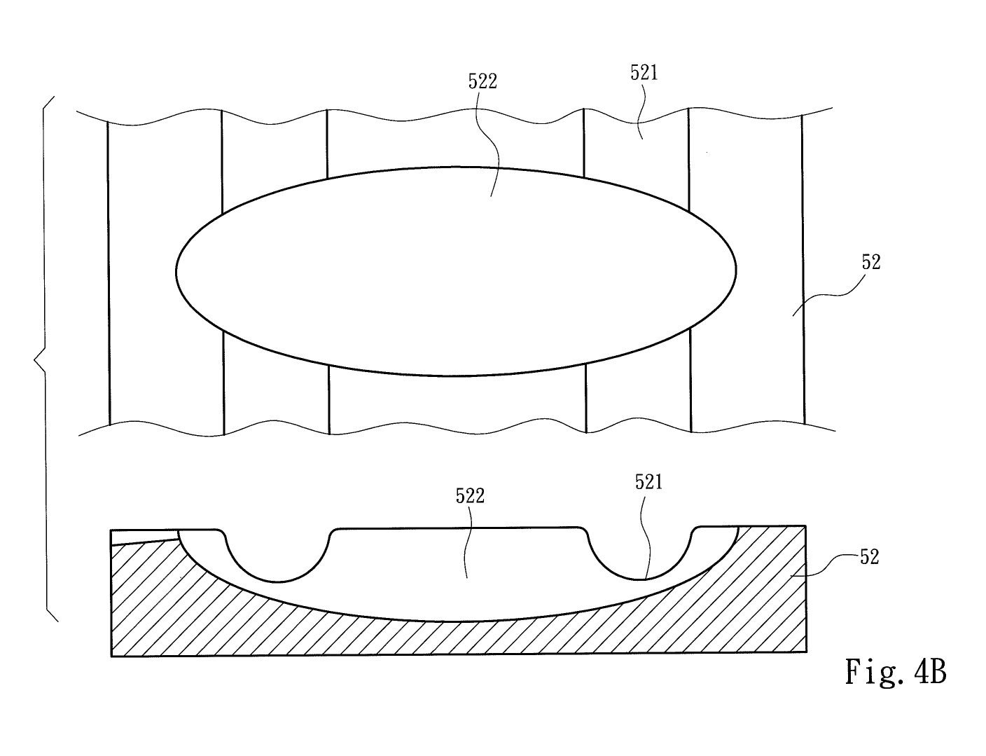

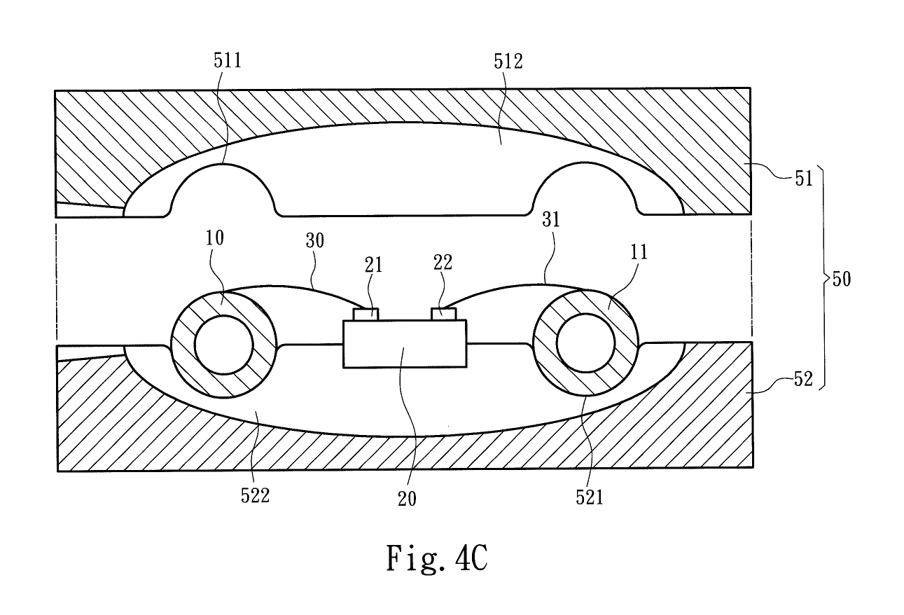

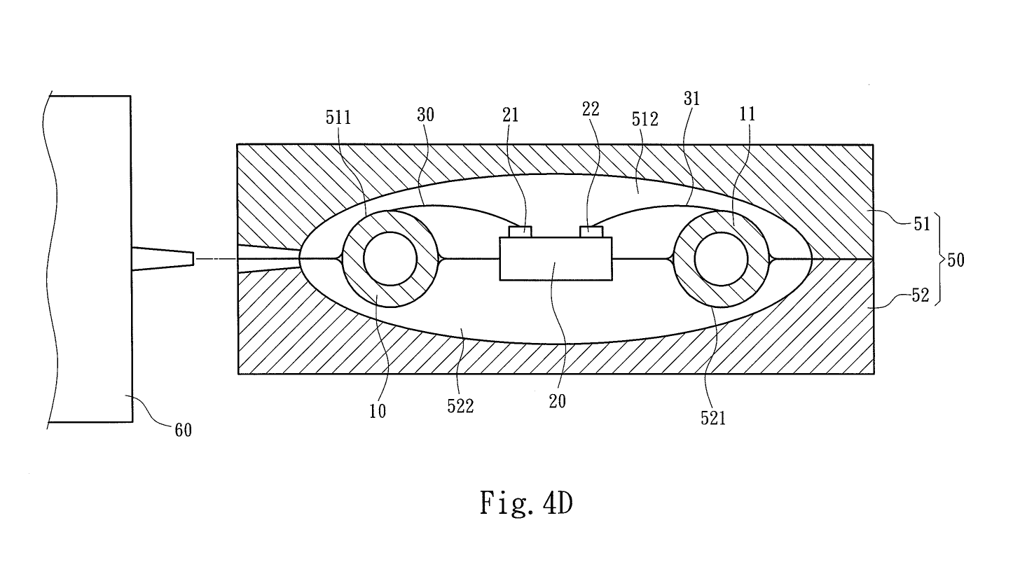

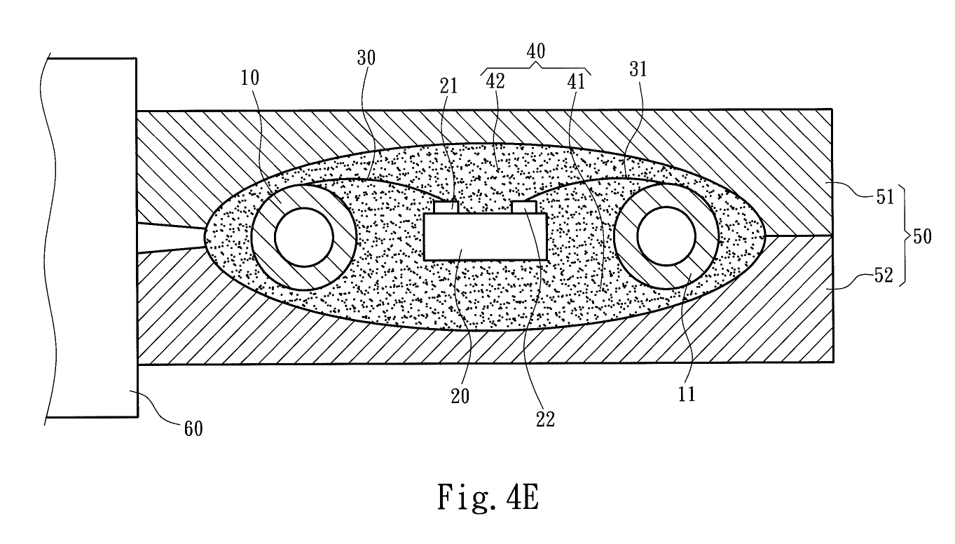

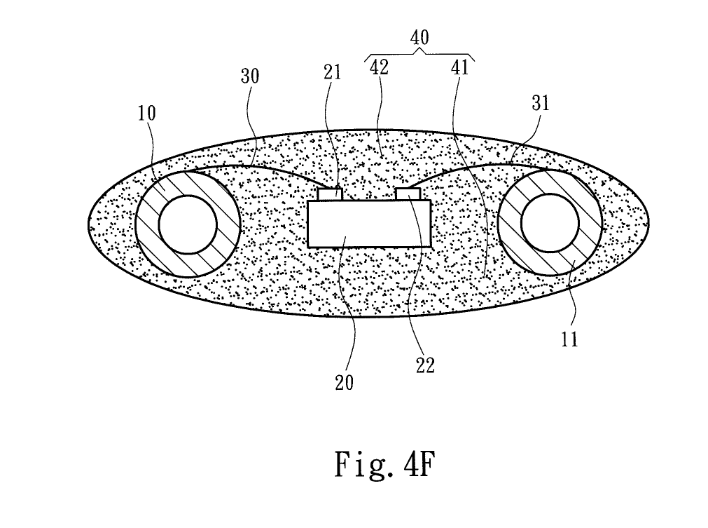

Please refer to FIGS. 4A through 4F for the fabrication process of an embodiment of the invention. The insulation holding layer 41 and insulation covering layer 42 of the package body 40 are respectively made of package material and integrally formed. The fabrication process is as follows: first, dispose a plurality of lighting elements 20 between the first and second conductive wires 10 and 11 spaced from each other at a constant or inconstant interval; next, connect the first conductive filament 30 to the first electrode 21 of the lighting element 20 and first conductive wire 10, and connect the second conductive filament 31 to the second electrode 22 of the lighting element 20 and second conductive wire 11 (referring to FIG. 4A); then place the connected first conductive wire 10, second conductive wire 11 and lighting element 20 into a mold 50 which includes an upper mold 51 and a lower mold 52 that have respectively an upper holding trough 511 and a lower holding trough 521 to hold the first conductive wire 10 and second conductive wire 11, and an upper recess 512 and a lower recess 522 corresponding to the lighting element 20 (referring to FIGS. 4B through 4D); next, inject the package material through an injection device 60 into the mold 50 to fill the upper and lower recesses 512 and 522 of the upper mold 51 and lower mold 52 (referring to FIG. 4E) to form the insulation holding layer 41 and insulation covering layer 42 to encase the lighting element 20, first and second conductive filaments 30 and 31, and first and second conductive wires 10 and 11 to finish the lamp string (referring to FIG. 4F).

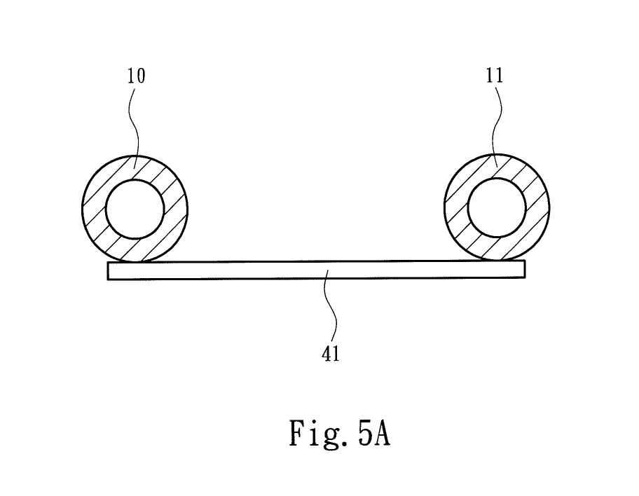

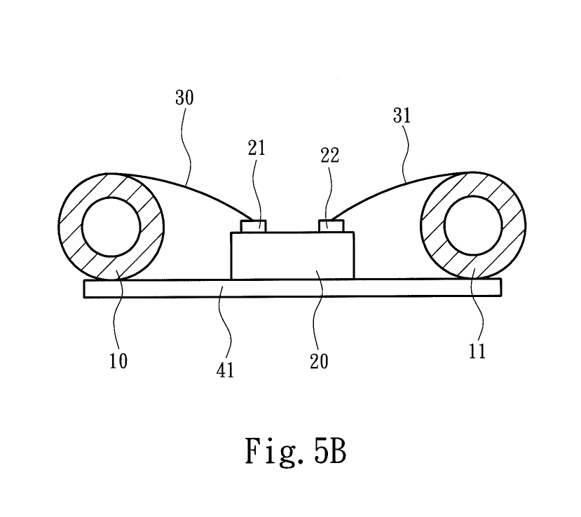

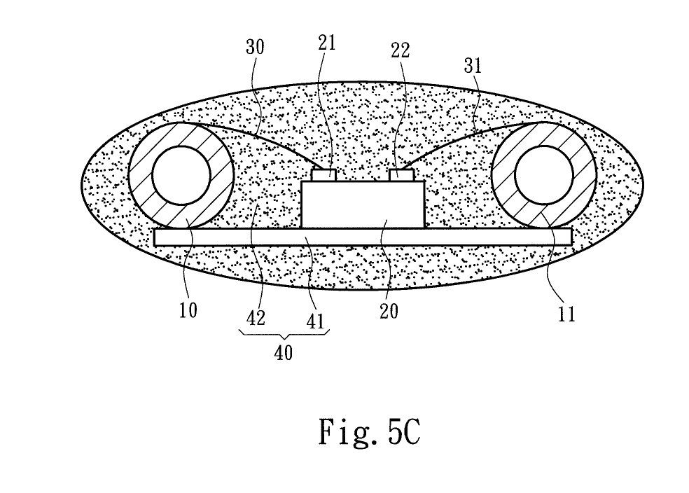

Please refer to FIGS. 5A through 5C for the fabrication process of another embodiment of the invention. The insulation holding layer 41 and insulation covering layer 42 are two independent elements with the insulation holding layer 41 being a transparent film platform and the insulation covering layer 42 being the package material to encase the insulation holding layer 41. During fabrication process, first, dispose the first and second conductive wires 10 and 11 at two sides of the insulation holding layer 41 (referring to FIG. 5A); next, dispose a plurality of lighting elements 20 on the insulation holding layer 41 spaced from each other at a constant or inconstant interval, and connect the first conductive filament 30 to the first electrode 21 of the lighting element 20 and first conductive wire 10, and connect the second conductive filament 31 to the second electrode 22 of the lighting element 20 and second conductive wire 11 (referring to FIG. 5B); finally, directly dispense the package material on the insulation holding layer 41 to form the insulation covering layer 42, or place the connected first and second conductive wires 10 and 11, insulation holding layer 41 and lighting element 20 into the mold 50 as shown in FIGS. 4B through 4D, and inject the package material to form the insulation covering layer 42 to encase the lighting element 20, first and second conductive filaments 30 and 31, and first and second conductive wires 10 and 11 (referring to FIG. 5C).

As a conclusion, the present invention mainly places the lighting element 20 between the first and second conductive wires 10 and 11, and connects the lighting element 20 to the first and second conductive wires 10 and 11 through the first and second conductive filaments 30 and 31. Through a package body 40 encasing the lighting element 20, an insulation holding layer 41 holding the lighting element 20 and an insulation covering layer 42 connected to the insulation holding layer 41 and covering the lighting element 20 are formed. Both the insulation holding layer 41 and insulation covering layer 42 of the package body 40 are light transparent. Compared with the conventional techniques, the invention provides many advantages, such as:

1. As the lighting element 20 is located between the first and second conductive wires 10 and 11, the lighting element 20 can emit light radially without being constrained by the conductive wires, thus can achieve wide-angle light projection and improve ornamental effect.

2. Based on the aforesaid feature, the first and second conductive wires 10 and 11 can be bent at greater angles without being hindered by the lighting element 20, thus can be wound and twisted as desired according to installation locations of the lamp string to offer greater flexibility.

3. As the lighting element 20 emits light radially, it can dissipate heat at the same time, hence does not create heat accumulation problem.

4. During assembly, the lighting element 20 is connected to the first and second conductive wires 10 and 11 via the first and second conductive filaments 30 and 31, thus no extra process on the first and second conductive wires 10 and 11 is needed, and production time also can be reduced.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A lamp string structure for emitting light within wide area, comprising:
a first conductive wire and a second conductive wire parallel with each other;
at least one lighting element located between the first conductive wire and the second conductive wire and including a first conductive filament and a second conductive filament to electrically connected with the first conductive wire and the second conductive wire respectively; and
a package body which encases the lighting element and includes an insulation holding layer to hold the lighting element and an insulation covering layer connected to the insulation holding layer to cover the lighting element, the insulation holding layer and the insulation covering layer being light transparent.

2. The lamp string structure of claim 1, wherein the insulation holding layer and the insulation covering layer are respectively made of package material and integrally formed in a mold.

3. The lamp string structure of claim 1, wherein the insulation holding layer is a transparent film platform and the insulation covering layer is made of package material to encase the insulation holding layer.

4. The lamp string structure of claim 1, wherein the insulation covering layer encases the first conductive filament, the second conductive filament, the first conductive wire and the second conductive wire.

5. The lamp string structure of claim 1, wherein the insulation holding layer encases the first conductive filament, the second conductive filament, the first conductive wire and the second conductive wire.

6. The lamp string structure of claim 1, wherein the lighting element is a light emitting diode dice.

7. The lamp string structure of claim 6, wherein the lighting element is a light emitting diode bipolar dice.

8. The lamp string structure of claim 6, wherein the lighting element is a light emitting diode mono-polar dice.

9. The lamp string structure of claim 1, wherein the lighting element is a surface mount device LED.
